(19) United States
(12) Patent Application Publication
(10) Pub. No.: US 2025/0199191 A1
(43) Pub. Date: Jun. 19, 2025

(54) METHODS TO ESTIMATE A BOUNDARY OF A DOWNHOLE FORMATION DATA AND DOWNHOLE FORMATION BOUNDARY ESTIMATION SYSTEMS

(71) Applicant: Halliburton Energy Services, Inc., Houston, TX (US)

(72) Inventors: Siyang SONG, Houston, TX (US); Tingting ZENG, Houston, TX (US); Robert P. DARBE, Houston, TX (US); Eirik HANSEN, Stavanger (NO)

(73) Assignee: Halliburton Energy Services, Inc., Houston, TX (US)

(21) Appl. No.: 18/545,271

(22) Filed: Dec. 19, 2023

(51) Int. Cl. G01V 1/28; E21B 44/00

(52) U.S. Cl. CPC G01V 1/282; E21B 44/00; G01V 2210/667

(57) ABSTRACT

A computer-implemented method to estimate a boundary of a downhole formation data includes obtaining an inversion model of a downhole formation. The method also includes defining a boundary of the downhole formation. The method further includes determining the boundary based on values associated with the inversion model. The method further includes organizing the boundary into one or more clusters. The method further includes determining uncertainties associated with the one or more clusters. The method further includes estimating the boundary based on the one or more clusters and the uncertainties

### BACKGROUND

The present disclosure relates generally to methods to estimate a boundary of a downhole formation data and downhole formation boundary estimation systems.

Inversion models of downhole resistivity are sometimes obtained and analyzed to determine downhole formation boundaries, and the location of hydrocarbon reservoirs. However, inversion models contain a degree of uncertainty such that the location of a boundary as indicated by an inversion model differs from the actual location of the boundary. Further, detecting a boundary from an inversion model may be challenging due to the degree of uncertainty of the corresponding resistivity, which also propagates to the depth of the boundary.

### BRIEF DESCRIPTION OF THE DRAWINGS

Illustrative embodiments of the present disclosure are described in detail below with reference to the attached drawing figures, which are incorporated by reference herein, and wherein:

FIG. 1 is a schematic, side view of a drilling environment where a downhole formation boundary estimation system is deployed;

FIG. 2A is an exemplary image of an inversion model of a downhole formation obtained by the downhole formation boundary estimation system of FIG. 1;

FIG. 2B is an exemplary image of a second inversion model of the downhole formation obtained by the downhole formation boundary estimation system of FIG. 1;

FIG. 3A is an exemplary plot of the resistivity values of the formation represented by the inversion model of FIG. 2A at a constant measured depth and along different true vertical depths;

FIG. 3B is an exemplary illustration of the resistivity values of the formation represented by the inversion model of FIG. 2A along different measured depths and true vertical depths;

FIG. 4A is an exemplary image of the inversion model of FIG. 2A, and having multiple clusters of boundary points indicative of boundaries of the downhole formation superimposed over the inversion model of FIG. 2A;

FIG. 4B is an exemplary image of another inversion model and having multiple clusters of contours indicative of two dimensional boundaries of the downhole formation superimposed over the inversion model;

FIG. 5 is an exemplary image of the inversion model of FIG. 2A, and having lines indicative of uncertainties of one of the clusters of FIG. 4A superimposed over the inversion model of FIG. 2A;

FIG. 6 is a block diagram of the downhole formation boundary estimation system of FIG. 1; and

FIG. 7 is a flow chart of a process to estimate a boundary of a downhole formation data.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid details not necessary to enable those skilled in the art to practice the embodiments described herein, the description may omit certain information known to those skilled in the art. Therefore, the following detailed description is not to be taken in a limiting sense, and the scope of the illustrative embodiments is defined only by the appended claims.

The present disclosure relates to methods to estimate a boundary of a downhole formation data and downhole formation boundary estimation systems. A downhole formation boundary estimation system described herein obtains inversion models of a downhole formation and/or other data (e.g., raw data containing magnitude attenuation and phase shifts between transmitters and receivers, data indicative of resistivity measurements/distributions of the downhole formation, pre-processed data, and post-processed data, and other types of data) indicative of the downhole formation (collectively “formation data”) that are generated by resistivity tools and other downhole tools (collectively “logging tools”). The downhole formation boundary estimation system performs. In some embodiments, the inversion models are generated in real-time during logging operations such as drilling operations and MWD/LWD operations. In some embodiments, some of the inversion models are existing models of the downhole formation are generated during previous operations. In some embodiments, the downhole formation boundary estimation system obtains multiple different inversion models (e.g., models generated from reading by different transmitter/receiver pairs, models generated from a logging tool operating in different modes, models generated from reading by different logging tools, and/or models, etc.) to perform operations described herein.

The downhole formation boundary estimation system analyzes the obtained models, and defines one or more boundaries of the downhole formation. In some embodiments, the downhole formation boundary estimation system defines the boundaries of the downhole formation based on one or more specific values such as corresponding absolute resistivity values. For example, the downhole formation boundary estimation system defines a first formation boundary based on a specific resistivity value at the corresponding location. In some embodiments, the downhole formation boundary estimation system defines the boundaries of the downhole formation based on a magnitude (e.g., a threshold ohm-meter) or percentage of change to the resistivity (e.g., a threshold percentage of change to the magnitude of the resistivity) at the corresponding location. In some embodiments, the downhole formation boundary estimation system defines the boundaries of the downhole formation based on a direction of change of the resistivity (e.g., from a first resistivity to a second resistivity that is higher than the first resistivity, or from the second resistivity to the first resistivity) at the corresponding location. For example, the downhole formation boundary estimation system determines a directional change from the first resistivity to the second resistivity (low to high) as the upper boundary of the formation, and defines a second directional change from the second resistivity to the first resistivity (high to low) as the lower boundary of the formation. In some embodiments, the downhole formation boundary estimation system defines the boundaries of the downhole formation based on one or more trends, such as the sharpness or smoothness of the change, how fast the resistivity changes, the range of the depth of the changes, and/or the gradient of the changes. In some embodiments, the downhole formation boundary estimation system defines the boundaries of the downhole formation based on one or more user specifications and/or definitions that are associated with the one or more inversion models.

In some embodiments, the downhole formation boundary estimation system provides different definitions to different dimensional boundaries. In one or more of such embodiments, the downhole formation boundary estimation system defines one dimensional boundaries based on directional changes (e.g., going from low to high as the upper boundary). In one or more of such embodiments, the downhole formation boundary system defines two dimensional boundaries based on one or more lines or contours indicative of resistivity or changes to resistivity (e.g., from 20 ohm-meter to 5 ohm-meter) across two axis (e.g., true vertical depth and measured depth). In one or more of such embodiments, the downhole formation boundary system defines three dimensional boundaries based on one or more bodies indicative of resistivity or changes to resistivity across three axis.

The downhole formation boundary estimation system performs operations described herein to determine the boundaries of the downhole formation. In some embodiments, where a boundary is one dimensional, the downhole formation boundary estimation system determines a set of boundary points along the boundary, where the set of boundary points are locations that define the boundary. More particularly, the downhole formation boundary estimation system determines, based on values associated with the inversion model, a set of boundary points along the boundary. In some embodiments, the values are specific resistivity values. For example, where the downhole formation boundary estimation system defines a first boundary (e.g., top boundary) as locations along the formation where the resistivity is 20 ohm-meters having a directional change from low resistivity to high resistivity (from less than 20 ohm-meters to greater than 20 ohm-meters), the downhole formation boundary estimation system analyzes an inversion model for corresponding locations along the formation where the resistivity is 20 ohm-meters and having a directional change from low resistivity to high resistivity. Similarly, where the downhole formation boundary estimation system defines a second boundary (e.g., bottom boundary) as locations along the formation where the resistivity is 20 ohm-meters having a directional change from high resistivity to low resistivity (from greater than 20 ohm-meters to less than 20 ohm-meters), the downhole formation boundary estimation system analyzes an inversion model for corresponding locations along the formation where the resistivity is 20 ohm-meters and having a directional change from high resistivity to low resistivity. In some embodiments, the values correspond to values within a specific range of resistivity, a contrast of resistivity, or a gradient of resistivity.

In some embodiments, where the inversion model is a three-dimensional model of the downhole formation formed from multiple two dimensional planes or slices, the downhole formation boundary estimation system analyzes each two dimensional plane or slice of the three-dimensional inversion model to determine the set of boundary points. In some embodiments, where the inversion model is a two-dimensional model, the downhole formation boundary estimation system analyzes each slice of the two-dimensional inversion model to determine the set of boundary points. For example, the downhole formation boundary estimation system slices a two-dimensional model of a resistivity map into multiple slices, each at a different measured depth of the formation. The downhole formation boundary estimation system then analyzes the resistivity values at each measured depth (slice) to determine the boundary points of the downhole formation. In some embodiments, where the downhole formation boundary estimation system utilizes multiple inversion models to estimate boundaries of a formation, the downhole formation boundary estimation system performs operations described herein for each inversion model of the multiple inversion models to determine the boundaries of the formation.

The downhole formation boundary estimation system organizes the boundaries into one or more clusters. In some embodiments, where a boundary is one dimensional, the downhole formation boundary estimation system clusters boundary points associated with the boundary by assigning the boundary points into one or more clusters. In some embodiments, the downhole formation boundary estimation system utilizes one or more of k-means, DBSCAN, Gaussian mixtures, Ward hierarchical clustering techniques, and other types of clustering techniques to assign the set of boundary points into the one or more clusters. In some embodiments, the downhole formation boundary estimation system clusters the boundary points based on spatial distance, such as the measured depth or the true vertical depth. In one or more of such embodiments, the downhole formation boundary estimation system identifies a subset of the boundary points that are within a threshold distance of each other, and/or within a threshold range of spatial location (measured depth, true vertical depth, easting/northing, etc.), and assigns the subset as a cluster. Continuing with the foregoing example, the downhole formation boundary estimation system assigns a first subset of boundary points within a threshold range of measured depth, having a corresponding resistivity of 20 ohm-meters, and having a directional change from low resistivity to high resistivity as a first cluster, and assigns a second subset of boundary points within a threshold range of measured depth, having a corresponding resistivity of 20 ohm-meters, and having a directional change from high resistivity to low resistivity as a second cluster. In some embodiments, the downhole formation boundary estimation system clusters the boundary points based on corresponding resistivity values. In one or more of such embodiments, the downhole formation boundary estimation system identifies a second subset of the set of boundary points that are within a threshold resistivity range of each other, and assigns all of the boundary points having corresponding resistivity values that are within the resistivity range to a second cluster. In some embodiments, the downhole formation boundary estimation system identifies one or more boundary points that are not assigned to a cluster as outliers, and ignore the outliers when estimating the locations of the boundaries.

In some embodiments, where a boundary is two dimensional, the downhole formation boundary estimation system clusters contours associated with the boundary by assigning the contours into one or more clusters. In some embodiments, where a boundary is three dimensional, the downhole formation boundary estimation system clusters bodies associated with the boundary by assigning the bodies into one or more clusters. In some embodiments, the downhole formation boundary estimation system utilizes one or more of k-means, DBSCAN, Gaussian mixtures, Ward hierarchical clustering techniques, and other types of clustering techniques to assign the contours of a two dimensional boundary and bodies of a three dimensional boundary into respective clusters. In some embodiments, the downhole formation boundary estimation system clusters the contours of a two dimensional boundary and bodies of a three dimensional boundary based on spatial distance, such as the measured depth or the true vertical depth. In one or more of such embodiments, the downhole formation boundary estimation system performs additional operations described herein to cluster the contours of a two dimensional boundary and bodies of a three dimensional boundary, and to form sub-clusters.

A degree of uncertainty of the locations of the boundary points, contours, bodies, and boundaries exists due to various factors including, but not limited to, discrepancies between different inversion models, discrepancies between different logging tools, discrepancies between different logging modes, downhole interferences, and other factors that contribute to a degree of uncertainty of the exact locations of the boundaries. In that regard, the downhole formation boundary estimation system determines various uncertainties associated with the clusters, the boundary points, contours, bodies, and the locations of the boundaries. In some embodiments, the downhole formation boundary estimation system determines the degree of uncertainty based on the range of spatial distance between the boundary points, the contours, and/or the bodies of a cluster. Continuing with the foregoing example, the downhole formation boundary estimation system determines the corresponding true vertical depth of each boundary point (or the measured depth, or the resistivity, or another value associated with the corresponding boundary point) of the first cluster, determines a mean of all of the corresponding valves, determines a size of the standard deviation (or two deviations, or root-mean-square, or another measurement of the dispersion of the boundary points), and determines the uncertainty associated with the cluster based on the value of the standard deviation. In one or more of such embodiments, the downhole formation boundary estimation system determines the cluster to have a first degree of uncertainty if the standard deviation value is greater than a standard deviation threshold, and determines the cluster to have a second degree of uncertainty that is less than the first degree of uncertainty if the first value is less than or equal to the first standard deviation threshold. In one or more of such embodiments, the degree of uncertainty of the cluster increases as the standard deviation increases, and wherein the uncertainty of the cluster decreases as the standard deviation decreases. In some embodiments, the downhole formation boundary estimation system utilizes quantile values, percentile values or other statistics-related measures to quantify the uncertainty, and performs operations described herein to determine the uncertainty associated with the cluster based on such statistic-related measurements.

The downhole formation boundary estimation system estimates the boundaries based on the locations of the clusters and the degrees of uncertainties associated with the clusters. In some embodiments, the downhole formation boundary estimation system provides one or more assessments of the boundary estimation to an electronic device of an operator. In one or more of such embodiments, the downhole formation boundary estimation system determines and/or assigns a certainty value indicative a certainty of a location of the boundaries at a particular cluster of boundary points based on the degree of uncertainty associated with the cluster, and provides the certainty value for display on an electronic device of an operator. In some embodiments, the downhole formation boundary estimation system dynamically determining a geosteering recommendation based on the estimated boundary, and provides the geosteering recommendation to an electronic device, such an electronic device of the operator. In some embodiments, the downhole formation boundary estimation system dynamically determines a geosteering recommendation based on the estimated boundary, and requests a drilling system to autonomously follow the geosteering recommendation.

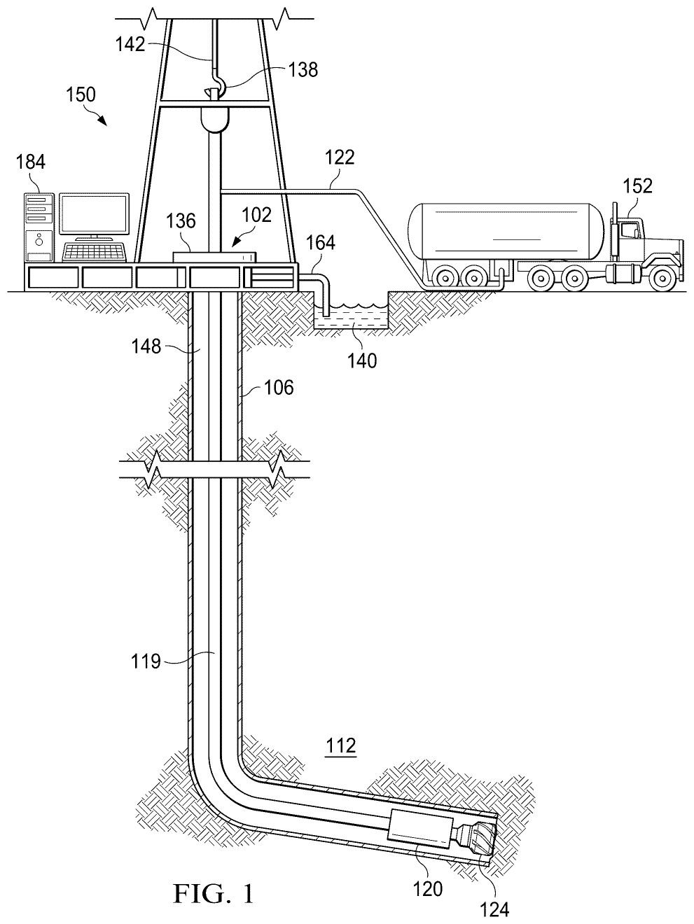

It is understood that the downhole formation boundary estimation system described herein is configured to simultaneously or sequentially perform operations described herein to define multiple boundaries, determine boundary points, contours, and/or bodies, associated with the different boundaries, form multiple clusters, determine varying degrees of certainties associated with the different clusters, and estimate the locations of the different clusters. Similarly, the downhole formation boundary estimation system described herein is configured to simultaneously or sequentially perform operations described herein to analyze multiple inversion models to determine varying degrees of certainties associated with the different clusters, and estimate the locations of the different clusters. Additional descriptions of the foregoing methods to estimate a boundary of a downhole formation data and downhole formation boundary estimation systems are described in the paragraphs below and are illustrated in FIGS. 1-7.

Turning now to the figures, FIG. 1 is a schematic, side view of a drilling environment 150 with a tool 120 deployed to measure the properties of formation 112 during a drilling operation. FIG. 1 may also represent another completion or preparation environment where a drilling operation is performed. A hook 138, cable 142, traveling block (not shown), and hoist (not shown) are provided to lower a drill string 119 down borehole 106 of well 102 or to lift drill string 119 up from borehole 106 of well 102.

At the wellhead 136, an inlet conduit 122 is coupled to a fluid source 152 to provide fluids, such as drilling fluids, downhole. The drill string 119 has an internal cavity that provides a fluid flow path from the surface down to tool 120. In some embodiments, the fluids travel down drill string 119, through tool 120, and exit drill string 119 at a drill bit 124. The fluids flow back towards the surface through a wellbore annulus 148 and exit the wellbore annulus 148 via an outlet conduit 164 where the fluids are captured in container 140.

In logging while drilling (LWD) systems, sensors or transducers (not shown) are typically located at the lower end of the drill string 119. In one or more embodiments, sensors employed in LWD applications are built into a cylindrical drill collar that is positioned close to drill bit 124. While drilling is in progress, these sensors continuously or intermittently determine the formation resistivity of the downhole formation proximate to drill bit 124, and transmit the information to a surface detector by one or more telemetry techniques, including, but not limited to, mud pulse telemetry, acoustic telemetry, and electromagnetic wave telemetry.

In one or more embodiments, where a mud pulse telemetry system is deployed in borehole 106 to provide telemetry, telemetry information is transmitted by adjusting the timing or frequency of viable pressure pulses in the drilling fluid that is circulated through drill string 119 during drilling operations. In one or more embodiments, an acoustic telemetry system that transmits data via vibrations in the tubing wall of the drill string 119 is deployed in borehole 106 to provide telemetry. More particularly, the vibrations are generated by an acoustic transmitter (not shown) mounted on drill string 119 and propagate along drill string 119 to an acoustic receiver (not shown) also mounted on drill string 119. In one or more embodiments, an electromagnetic wave telemetry system that transmits data using current flows induced in drill string 119 is deployed in borehole 106 to provide telemetry. Additional types of telemetry systems may also be deployed in borehole 106 to transmit data from tool 120 and other downhole components to downhole formation boundary estimation system 184.

Tool 120 is also operable to obtain measurements of the resistivity of the formation 112 and provide data indicative of the formation resistivity to downhole formation boundary estimation system 184. Additional descriptions of the operations performed by tool 120 are provided in the paragraphs below. Downhole formation boundary estimation system 184 includes a storage medium and one or more processors configured to obtain inversion models of a formation 112. In some embodiments, the inversion models are existing models that are stored locally or remotely (such as in the cloud). In some embodiments, the inversion models are models that are dynamically generated in real-time during a drilling operation. The processors are also configured to define boundaries of formation 112, determine boundary points along the boundaries, assign different sets of boundary points into one or more clusters, determine uncertainties associated with the one or more clusters, estimate the boundary based on the one or more clusters and the uncertainties, and perform other operations described herein. In some embodiments, operations performed by downhole formation boundary estimation system 184 are performed in real-time during a drilling operation to dynamically determine the boundaries of the formation 112 to provide an operator with real-time estimates on the locations and degree of uncertainty of the locations of the boundaries. In some embodiments, the processors of downhole formation boundary estimation system 184 are configured to dynamically and/or autonomously request drill bit 124 to adjust a drilling path based on the real-time estimates on the locations and degree of uncertainty of the locations of the boundaries. Although FIG. 1 illustrates downhole formation boundary estimation system 184 as a surface-based system, in some embodiments, some components of downhole formation boundary estimation system 184 are located downhole, remotely, and/or in the cloud. Additional descriptions of downhole formation boundary estimation system 184 and operations performed by the processors of downhole formation boundary estimation system 184 are described in the paragraphs below.

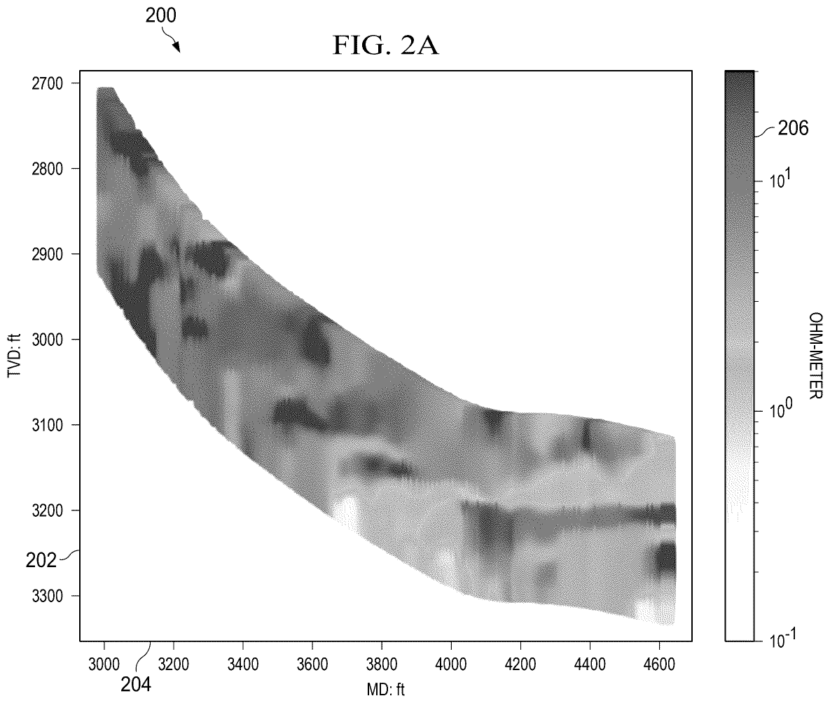

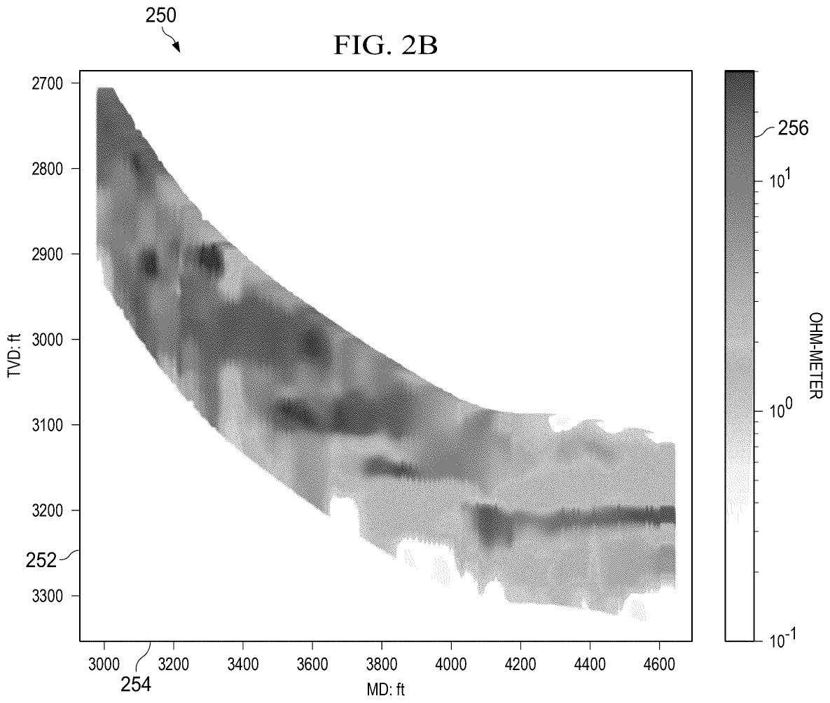

FIG. 2A is an exemplary image 200 of an inversion model of a downhole formation obtained by the downhole formation boundary estimation system of FIG. 1. FIG. 2B is an exemplary image 250 of a second inversion model of the downhole formation obtained by the downhole formation boundary estimation system of FIG. 1. In the embodiment of FIG. 2A, axis 202 is the true vertical depth, axis 204 is the measured depth, and spectrum 206 is a spectrum of the resistivity values at different measured depths and true vertical depths of the formation. In the embodiment of FIG. 2B, axis 252 is the true vertical depth, axis 254 is the measured depth, and spectrum 256 is a spectrum of the resistivity values at different measured depths and true vertical depths of the formation. In some embodiments, the downhole formation boundary estimation system obtains a different number of inversion maps to perform the operations described herein to estimate boundaries of the downhole formation. In some embodiments, the downhole formation boundary estimation system simultaneously analyzes multiple inversion maps to define boundaries of the formation, and perform other operations described herein.

In some embodiments, where the inversion model is a three-dimensional model of the downhole formation formed from multiple two dimensional planes or slices, the downhole formation boundary estimation system analyzes each two dimensional plane or slice of the three-dimensional inversion model to determine the set of boundary points. In some embodiments, where the inversion model is a two-dimensional model, the downhole formation boundary estimation system analyzes each slice of the two-dimensional inversion model to determine the set of boundary points. For example, the downhole formation boundary estimation system slices a two-dimensional model of a resistivity map into multiple slices, each at a different measured depth of the formation. The downhole formation boundary estimation system then analyzes the resistivity values at each measured depth (slice) to determine the boundary points of the downhole formation.

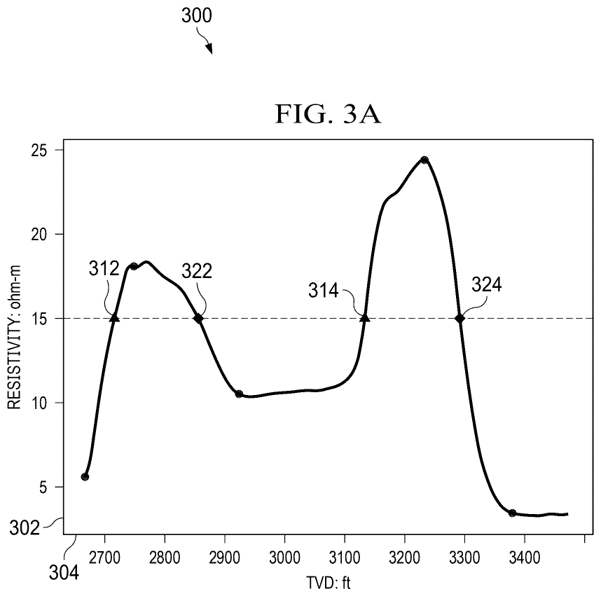

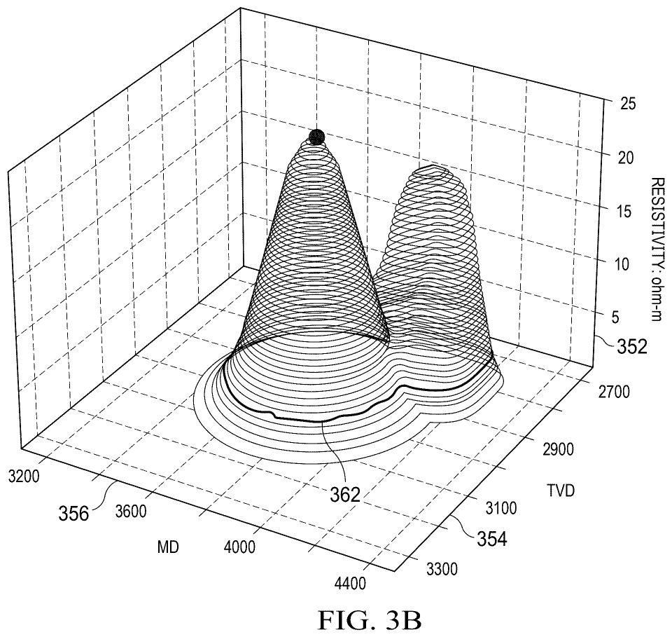

In that regard, FIG. 3A is an exemplary plot 300 of the resistivity values of the formation represented by the inversion model of FIG. 2A at a constant measured depth and along different true vertical depths. In the embodiment of FIG. 3A, axis 302 represents the resistivity value, and axis 304 represents the true vertical depth at a specific measured depth of the formation. Further, in the embodiment of FIG. 3A, the downhole formation boundary estimation system defines a top boundary as locations along the formation where the resistivity is 15 ohm-meters having a directional change from low resistivity to high resistivity, a bottom boundary as locations along the formation where the resistivity is 15 ohm-meters having a directional change from high resistivity to low resistivity. The downhole formation boundary estimation system analyzes the resistivity values of plot 300, and determines that points 312 and 314 represent the bottom boundary at approximately 2,700 and 3,150 feet of true vertical depth where the resistivity is 15 ohm-meters and increasing, and points 314 and 324 represent the top boundary at approximately 2,850 and 3,300 feet of true vertical depth where the resistivity is 15 ohm-meters and decreasing. In some embodiments, the downhole formation boundary estimation system defines the boundaries based on a different threshold resistivity. In some embodiments, the downhole formation boundary estimation system defines the boundaries of the downhole formation based on a magnitude (e.g., a threshold ohm-meter) or percentage of change to the resistivity (e.g., a threshold percentage of change to the magnitude of the resistivity) at the corresponding location.

FIG. 3B is an exemplary three-dimensional illustration 350 of the resistivity values of the formation represented by the inversion model of FIG. 2A along different measured depths and true vertical depths. In the embodiment of FIG. 3B, axis 352 represents the resistivity value, axis 354 represents the true vertical depth of the formation, and axis 356 represents the measured depth of the formation. Further, in the embodiment of FIG. 3B, the downhole formation boundary estimation system defines a boundary as line or contour where the resistivity is 5 ohm-meters along different true measured depths and vertical depths. The downhole formation boundary estimation system analyzes the resistivity values of three-dimensional illustration 350, and determines the corresponding true vertical depths and measured depths where the resistivity is 5 ohm-meters. In another example, where the downhole formation boundary estimation system defines a boundary as resistivity changes from 20 ohm-meters to 5 ohm-meters, the downhole formation boundary estimation system analyzes the resistivity values across each inversion model to determine contours along which the resistivity changes from 20 ohm-meters to 5 ohm-meters.

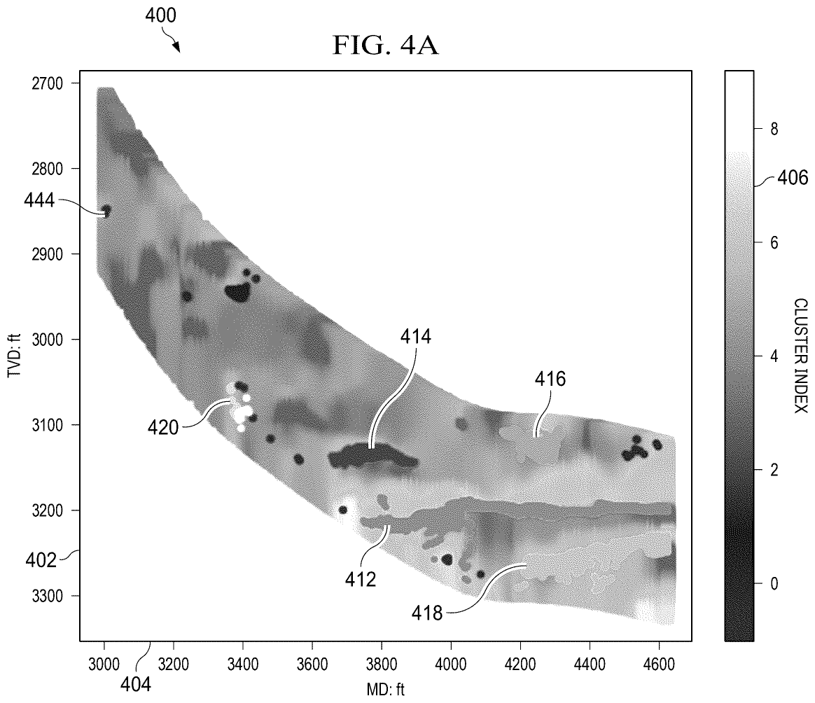

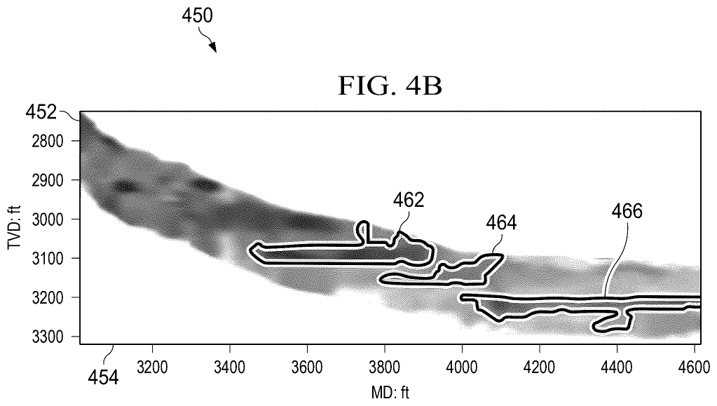

In some embodiments, where the boundary is one dimensional, the downhole formation boundary estimation system, after identifying boundary points of the downhole formation, clusters the boundary points by assigning the boundary points into one or more clusters. In that regard, FIG. 4A is an exemplary image 400 of the inversion model of FIG. 2A, and having multiple clusters of boundary points indicative of boundaries of the downhole formation superimposed over the inversion model of FIG. 2A. In the embodiment of FIG. 4A, axis 402 is the true vertical depth of the formation, axis 404 is the measured depth of the formation, and spectrum 406 is a spectrum of different clusters of boundary points identified and assigned by the downhole formation boundary estimation system. In the embodiment of FIG. 4A, identified clusters include clusters 412, 414, 416, 418, and 420.

In some embodiments, the downhole formation boundary estimation system utilizes one or more of k-means, DBSCAN, Gaussian mixtures, Ward hierarchical clustering techniques, and other types of clustering techniques to assign the set of boundary points into the one or more clusters. In the embodiment of FIG. 4A, the downhole formation boundary estimation system clusters the boundary points based on boundary points having identical or true vertical depth within a threshold range. For example, cluster 412 represent boundary points at or within a threshold range of 3,200 feet of true vertical depth. Further, in the embodiment of FIG. 4A, the downhole formation boundary estimation system identifies boundary point 444 as an outlier, does not assign point 444 to any cluster, and ignores point 444 and other outliers when estimating the locations of the boundaries.

In some embodiments, where the boundary is two dimensional, the downhole formation boundary estimation system, after identifying contours of the downhole formation, assigns the contours into one or more clusters. In that regard, FIG. 4B is an exemplary image 450 of another inversion model and having multiple clusters of contours indicative of two dimensional boundaries of the downhole formation superimposed over the inversion model. In the embodiment of FIG. 4B, axis 452 is the true vertical depth of the formation, and axis 454 is the measured depth of the formation. In the embodiment of FIG. 4B, identified clusters of contours include clusters 462, 464, and 466. In some embodiments, the downhole formation boundary estimation system utilizes one or more of k-means, DBSCAN, Gaussian mixtures, Ward hierarchical clustering techniques, and other types of clustering techniques to assign the set of contours into the one or more clusters. In some embodiments, where the boundary is three dimensional, the downhole formation boundary estimation system, after identifying bodies of the downhole formation, assigns the bodies into one or more clusters.

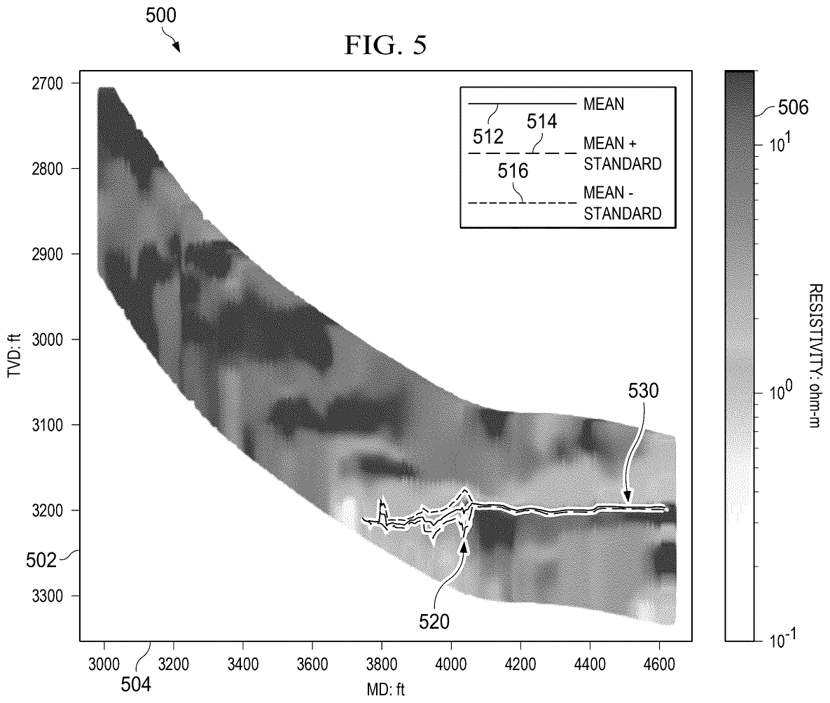

The downhole formation boundary estimation system determines various uncertainties associated with the clusters, the boundary points, and the locations of the boundaries. In that regard, FIG. 5 is an exemplary image 500 of the inversion model of FIG. 2A, and having lines indicative of uncertainties of the degree of uncertain of cluster 412 of FIG. 4A superimposed over the inversion model of FIG. 2A. In the embodiment of FIG. 5, axis 502 is the true vertical depth, axis 504 is the measured depth, and spectrum 506 is a spectrum of the resistivity values at different measured depths and true vertical depths of the formation. Further, line 502 represents the mean value of the resistivity values of the boundary points of cluster 412, line 514 represents the sum of the mean value and a standard deviation of the resistivity values, and line 516 represents the difference between the mean value and the standard deviation of the resistivity values. In the embodiment of FIG. 5, the downhole formation boundary estimation system determines the degree of uncertainty of the actual location of the boundary based on the separation of lines 514 and 516, where a larger separation such as at point 520 represents greater uncertainty, and where a smaller separation such as at point 530 represents less uncertainty.

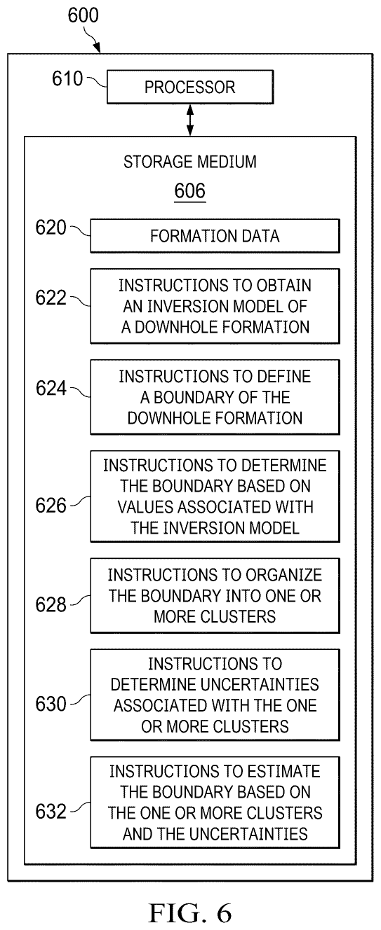

FIG. 6 is a block diagram 600 of the downhole formation boundary estimation system 184 of FIG. 1, and that is configured to perform the operations illustrated in process 600 of FIG. 6. Downhole formation boundary estimation system 600 includes a storage medium 606 and a processor 610. The storage medium 606 may be formed from data storage components such as, but not limited to, read-only memory (ROM), random access memory (RAM), flash memory, magnetic hard drives, solid state hard drives, CD-ROM drives, DVD drives, floppy disk drives, as well as other types of data storage components and devices. In some embodiments, the storage medium 606 includes multiple data storage devices. In further embodiments, the multiple data storage devices may be physically stored at different locations. In one of such embodiments, the data storage devices are components of a server station, such as a cloud server. Formation data is stored at a first location 620 of storage medium 606. Further, instructions to obtain an inversion model of a downhole formation are stored at a second location 622 of storage medium 606. Further, instructions to define a boundary of the downhole formation are stored at a third location 624 of storage medium 606. Further, instructions to determine the boundary based on values associated with the inversion model are stored at a fourth location 626 of storage medium 606. Further, instructions to organize the boundary into one or more clusters are stored at a fifth location 628 of storage medium 606. Further, instructions to determine uncertainties associated with the one or more clusters are stored at a sixth location 630 of storage medium 606. Further, instructions to estimate the boundary based on the one or more clusters and the uncertainties are stored at a seventh location 632 of storage medium 606. Additional instructions to perform operations described herein are also stored at various locations of storage medium 606.

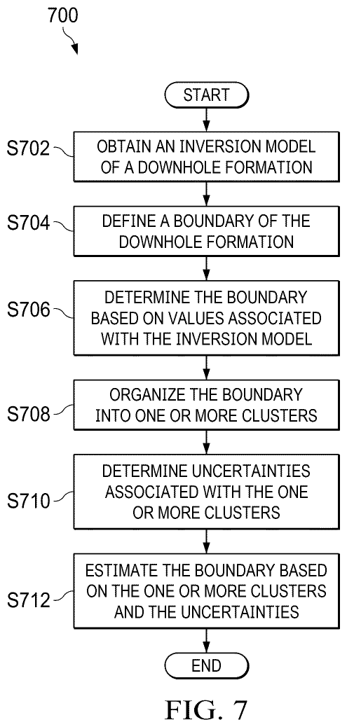

FIG. 7 is a flow chart of process 700 to estimate a boundary of a downhole formation data. Although the operations in process 700 are shown in a particular sequence, certain operations may be performed in different sequences or at the same time where feasible.

At block 702, the downhole formation boundary estimation system obtains an inversion model of a downhole formation. In that regard, FIGS. 2A and 2B illustrate two exemplary images 200 and 250 of inversion models obtained by the downhole formation boundary estimation system. At block 704, the downhole formation boundary estimation system defines a boundary of the downhole formation. FIG. 3A for example, illustrates a top boundary defined as 15 ohm meters and increasing in resistance, and bottom boundary defined as 15 ohm meters and decreasing in resistance. At block 706, the downhole formation boundary estimation system determines the boundary based on values associated with the inversion model. At block 708, the downhole formation boundary estimation system organizes the boundary into one or more clusters. In that regard, in the embodiment of FIG. 4A, where the boundary is one dimensional, the downhole formation boundary estimation system assigns boundary points of the boundary to multiple clusters including clusters 412, 414, 416, 418, and 420. Similarly, in the embodiment of FIG. 4B, where the boundary is two dimensional, the downhole formation boundary estimation system assigns the contours to multiple clusters including clusters 462, 464, and 466.

At block 710, the downhole formation boundary estimation system determines uncertainties associated with the one or more clusters. In that regard, in the embodiment of FIG. 5, the downhole formation boundary estimation system determines the degree of uncertain of cluster 412 of FIG. 4A based on the mean value and the standard deviation of the resistivity of the boundary points of cluster 412. At block 712, the downhole formation boundary estimation system estimates the boundary based on the one or more clusters and the uncertainties.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence, or combined into a single step/process. The scope of the claims is intended to broadly cover the disclosed embodiments and any such modification. Further, the following clauses represent additional embodiments of the disclosure and should be considered within the scope of the disclosure.

Clause 1, a computer-implemented method to estimate a boundary of a downhole formation, comprising: obtaining an inversion model of a downhole formation; defining a boundary of the downhole formation; determining the boundary based on values associated with the inversion model; organizing the boundary into one or more clusters; determining uncertainties associated with the one or more clusters; and estimating the boundary based on the one or more clusters and the uncertainties.

Clause 2, the computer-implemented method of clause 1, wherein determining the boundary comprises determining, based on values associated with the inversion model, at least one of a set of boundary points, a contour, and a body along the boundary, and wherein organizing the boundary comprises assigning at least one of the set of boundary points, the contour, and the body into the one or more clusters.

Clause 3, the computer-implemented method of clause 2, further comprising: identifying a subset of the set of boundary points that are within a threshold distance of each other, wherein assigning the set of boundary points comprises assigning the subset as one cluster of the one or more clusters.

Clause 4, the computer-implemented method of clause 3, further comprising: determining a corresponding value associated with a respective boundary point for each boundary point of the subset of boundary points; determining one or a mean value of the subset of boundary points; determining a standard deviation of the subset of boundary points; wherein determining the uncertainties associated with the one or more clusters comprises: assigning the uncertainty of the cluster a first value if the standard deviation is greater than a first standard deviation threshold; and assigning the uncertainty of the cluster a second value that is less than the first value if the standard deviation is less than or equal to first standard deviation threshold.

Clause 5, the computer-implemented method of clause 4, wherein the corresponding value is a true vertical depth of the respective boundary point, wherein the mean value is the mean vertical depth of the subset of boundary points, and wherein the standard deviation is the standard deviation of all values associated with the subset of boundary points.

Clause 6, the computer-implemented method of clauses 4 or 5, wherein the uncertainty of the cluster increases as the standard deviation increases, and wherein the uncertainty of the cluster decreases as the standard deviation decreases.

Clause 7, the computer-implemented method of any of clauses 2-6, further comprising: identifying a subset of the set of boundary points that are within a resistivity range of each other, wherein assigning the set of boundary points comprises assigning the subset as one cluster of the one or more clusters.

Clause 8, the computer-implemented method of any of clauses 2-7, wherein the inversion model is a three dimensional model comprising a plurality of two dimensional slices, and wherein determining the one or more boundary points along the boundary comprises determining, for each slice of the plurality of two dimensional slices, the one or more boundary points along the boundary based on corresponding values associated with the respective slice of the plurality of two dimensional slices.

Clause 9, the computer-implemented method of any of clauses 2-8, further comprising: determining, based on the boundary and the uncertainties, a certainty value indicative a certainty of a location of the boundaries at the set of boundary points; and providing the certainty value for display on an electronic device of an operator.

Clause 10, the computer-implemented method of any of clauses 1-9, further comprising utilizing one or more of k-means, DBSCAN, Gaussian mixtures, Ward hierarchical clustering technique to assign the boundary into the one or more clusters.

Clause 11, the computer-implemented method of any of claims 1-10, further comprising: dynamically determining a geosteering recommendation based on the estimated boundary; and providing the geosteering recommendation to an electronic device.

Clause 12, the computer-implemented method of any of claims 1-11, further comprising: dynamically determining a geosteering recommendation based on the estimated boundary; and requesting a drilling system to autonomously follow the geosteering recommendation.

Clause 13, the computer-implemented method of any of clauses 1-12, further comprising: obtaining an inversion model of a downhole formation; defining a second boundary of the downhole formation; determining the second boundary based on the values associated with the inversion model; organizing the second boundary into a second set of one or more clusters; determining uncertainties associated with the second set of one or more clusters; and estimating the second boundary based on the second set one or more clusters and the uncertainties associated with the second set of one or more clusters.

Clause 14, the computer-implemented method of any of clauses 1-13, further comprising: obtaining a second inversion model of the downhole formation; defining a second boundary of the downhole formation; determining the second boundary based on values associated with the second inversion model; organizing the second boundary into a second set of one or more clusters; determining uncertainties associated with the second set of one or more clusters; and estimating the second boundary based on the second set one or more clusters and the uncertainties associated with the second set of one or more clusters.

Clause 15, the computer-implemented method of any of clauses 1-14, wherein defining the boundary of the downhole formation comprises defining the boundary based on one or more of a specific resistivity value, a magnitude of the resistivity value, a percentage change to the resistivity value, a trend with respect to the resistivity value, and a user specified value that is associated with the inversion model.

Clause 16, a downhole formation boundary estimation system, comprising: a storage medium; and one or more processors configured to: obtain an inversion model of a downhole formation; define a boundary of the downhole formation; determine the boundary based on values associated with the inversion model; organize the boundary into one or more clusters; determine uncertainties associated with the one or more clusters; and estimate the boundary based on the one or more clusters and the uncertainties.

Clause 17, the downhole formation boundary estimation system of clause 16, wherein the one or more processors are further configured to: determine, based on values associated with the inversion model, at least one of a set of boundary points, a contour, and a body along the boundary; assign at least one of the set of boundary points, the contour, and the body into the one or more clusters; identify a subset of the set of boundary points that are within a threshold distance of each other; and assign the subset as one cluster of the one or more clusters.

Clause 18, the downhole formation boundary estimation system of clause 17, wherein the one or more processors are further configured to: determine a corresponding value associated with a respective boundary point for each boundary point of the subset of boundary points, wherein the corresponding value is a true vertical depth of the respective boundary point; determine one or a mean value of the subset of boundary points, wherein the mean value is the mean vertical depth of the subset of boundary points; determine a standard deviation of the subset of boundary points, wherein the standard deviation is the standard deviation of all values associated with the subset of boundary points; assign the uncertainty of the cluster a first value if the standard deviation is greater than a first standard deviation threshold; and assign the uncertainty of the cluster a second value that is less than the first value if the standard deviation is less than or equal to first standard deviation threshold.

Clause 19, a non-transitory machine-readable medium comprising instructions, which when executed by one or more processors, cause the processors to perform operations comprising: obtaining an inversion model of a downhole formation; defining a boundary of the downhole formation; determining the boundary based on values associated with the inversion model; organizing the set of boundary points into one or more clusters; determining uncertainties associated with the one or more clusters; and estimating the boundary based on the one or more clusters and the uncertainties.

Clause 20, the non-transitory machine-readable medium of clause 19, wherein defining the boundary of the downhole formation comprises defining the boundary based on one or more of a specific resistivity value, a magnitude of the resistivity value, a percentage change to the resistivity value, a trend with respect to the resistivity value, and a user specified value that is associated with the inversion model.

As used herein, the singular forms “a,” “an,” and “the” are intended to include the plural forms as well, unless the context clearly indicates otherwise. It will be further understood that the terms “comprise” and/or “comprising,” when used in this specification and/or in the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A computer-implemented method to estimate a boundary of a downhole formation, comprising:
obtaining an inversion model of a downhole formation;
defining a boundary of the downhole formation;
determining the boundary based on values associated with the inversion model;
organizing the boundary into one or more clusters;
determining uncertainties associated with the one or more clusters; and
estimating the boundary based on the one or more clusters and the uncertainties.

2. The computer-implemented method of claim 1, wherein determining the boundary comprises determining, based on values associated with the inversion model, at least one of a set of boundary points, a contour, and a body along the boundary, and wherein organizing the boundary comprises assigning at least one of the set of boundary points, the contour, and the body into the one or more clusters.

3. The computer-implemented method of claim 2, further comprising:
identifying a subset of the set of boundary points that are within a threshold distance of each other,
wherein assigning the set of boundary points comprises assigning the subset as one cluster of the one or more clusters.

4. The computer-implemented method of claim 3, further comprising:
determining a corresponding value associated with a respective boundary point for each boundary point of the subset of boundary points;
determining one or a mean value of the subset of boundary points;
determining a standard deviation of the subset of boundary points;
wherein determining the uncertainties associated with the one or more clusters comprises:
assigning the uncertainty of the cluster a first value if the standard deviation is greater than a first standard deviation threshold; and
assigning the uncertainty of the cluster a second value that is less than the first value if the standard deviation is less than or equal to first standard deviation threshold.

5. The computer-implemented method of claim 4, wherein the corresponding value is a true vertical depth of the respective boundary point, wherein the mean value is the mean vertical depth of the subset of boundary points, and wherein the standard deviation is the standard deviation of all values associated with the subset of boundary points.

6. The computer-implemented method of claim 4, wherein the uncertainty of the cluster increases as the standard deviation increases, and wherein the uncertainty of the cluster decreases as the standard deviation decreases.

7. The computer-implemented method of claim 2, further comprising:
identifying a subset of the set of boundary points that are within a resistivity range of each other,
wherein assigning the set of boundary points comprises assigning the subset as one cluster of the one or more clusters.

8. The computer-implemented method of claim 2, wherein the inversion model is a three dimensional model comprising a plurality of two dimensional slices, and wherein determining the one or more boundary points along the boundary comprises determining, for each slice of the plurality of two dimensional slices, the one or more boundary points along the boundary based on corresponding values associated with the respective slice of the plurality of two dimensional slices.

9. The computer-implemented method of claim 2, further comprising:
determining, based on the boundary and the uncertainties, a certainty value indicative a certainty of a location of the boundaries at the set of boundary points; and
providing the certainty value for display on an electronic device of an operator.

10. The computer-implemented method of claim 1, further comprising utilizing one or more of k-means, DBSCAN, Gaussian mixtures, Ward hierarchical clustering technique to assign the boundary into the one or more clusters.

11. The computer-implemented method of claim 1, further comprising:
dynamically determining a geosteering recommendation based on the estimated boundary; and
providing the geosteering recommendation to an electronic device.

12. The computer-implemented method of claim 1, further comprising:
dynamically determining a geosteering recommendation based on the estimated boundary; and
requesting a drilling system to autonomously follow the geosteering recommendation.

13. The computer-implemented method of claim 1, further comprising:
obtaining an inversion model of a downhole formation;
defining a second boundary of the downhole formation;
determining the second boundary based on the values associated with the inversion model;
organizing the second boundary into a second set of one or more clusters;
determining uncertainties associated with the second set of one or more clusters; and
estimating the second boundary based on the second set one or more clusters and the uncertainties associated with the second set of one or more clusters.

14. The computer-implemented method of claim 1, further comprising:
obtaining a second inversion model of the downhole formation;
defining a second boundary of the downhole formation;
determining the second boundary based on values associated with the second inversion model;
organizing the second boundary into a second set of one or more clusters;
determining uncertainties associated with the second set of one or more clusters; and
estimating the second boundary based on the second set one or more clusters and the uncertainties associated with the second set of one or more clusters.

15. The computer-implemented method of claim 1, wherein defining the boundary of the downhole formation comprises defining the boundary based on one or more of a specific resistivity value, a magnitude of the resistivity value, a percentage change to the resistivity value, a trend with respect to the resistivity value, and a user specified value that is associated with the inversion model.

16. A downhole formation boundary estimation system, comprising:
a storage medium; and
one or more processors configured to:
obtain an inversion model of a downhole formation;
define a boundary of the downhole formation;
determine the boundary based on values associated with the inversion model;
organize the boundary into one or more clusters;
determine uncertainties associated with the one or more clusters; and
estimate the boundary based on the one or more clusters and the uncertainties.

17. The downhole formation boundary estimation system of claim 16, wherein the one or more processors are further configured to:
determine, based on values associated with the inversion model, at least one of a set of boundary points, a contour, and a body along the boundary;
assign at least one of the set of boundary points, the contour, and the body into the one or more clusters;
identify a subset of the set of boundary points that are within a threshold distance of each other; and
assign the subset as one cluster of the one or more clusters.

18. The downhole formation boundary estimation system of claim 17, wherein the one or more processors are further configured to:
determine a corresponding value associated with a respective boundary point for each boundary point of the subset of boundary points, wherein the corresponding value is a true vertical depth of the respective boundary point;
determine one or a mean value of the subset of boundary points, wherein the mean value is the mean vertical depth of the subset of boundary points;
determine a standard deviation of the subset of boundary points, wherein the standard deviation is the standard deviation of all values associated with the subset of boundary points;
assign the uncertainty of the cluster a first value if the standard deviation is greater than a first standard deviation threshold; and
assign the uncertainty of the cluster a second value that is less than the first value if the standard deviation is less than or equal to first standard deviation threshold.

19. A non-transitory machine-readable medium comprising instructions, which when executed by one or more processors, cause the processors to perform operations comprising:
obtaining an inversion model of a downhole formation;
defining a boundary of the downhole formation;
determining the boundary based on values associated with the inversion model;
organizing the set of boundary points into one or more clusters;
determining uncertainties associated with the one or more clusters; and
estimating the boundary based on the one or more clusters and the uncertainties.

20. The non-transitory machine-readable medium of claim 19, wherein defining the boundary of the downhole formation comprises defining the boundary based on one or more of a specific resistivity value, a magnitude of the resistivity value, a percentage change to the resistivity value, a trend with respect to the resistivity value, and a user specified value that is associated with the inversion model.
